(19) United States
(12) Patent Application Publication
(10) Pub. No.: US 2008/0079365 A1
(43) Pub. Date: Apr. 3, 2008

(54) Plasma display panel and manufacturing method thereof

(75) Inventors: Akira Tokai, Hyogo (JP); Shigeo Kasahara, Hyogo (JP)

Correspondence Address: MCDERMOTT WILL & EMERY LLP, 600 13TH STREET, N.W., WASHINGTON, DC, 20005-3096, US

(73) Assignee: FUJITSU HITACHI PLASMA DISPLAY LIMITED

(21) Appl. No.: 11/802,796

(22) Filed: May 25, 2007

(30) Foreign Application Priority Data
Sep. 29, 2006 (JP) 2006-268243

(51) Int. Cl. H01J 17/49

(52) U.S. Cl. 313/586; 445/25

(57) ABSTRACT

A plasma display panel includes a pair of substrates and spacers. On one of the substrates, closed-type barrier ribs for dividing a discharge space into respective cells are formed. The one of the substrates is aligned face to face with the other substrate. The peripheral portion of the substrates is sealed by a sealing material that is softened by applying heat thereto. The spacers are softened at a temperature higher than the softening temperature of the sealing material at the time of applying heat during sealing the substrates and used for bonding top portions of the barrier ribs and the other substrate to each other. The spacers are placed between the top portion of the barrier ribs formed on the one of the substrates and the other substrate.

### CROSS-REFERENCE TO RELATED APPLICATION

This application is related to Japanese application No. 2006-268243 filed on Sep. 29, 2006 whose priority is claimed under 35 USC §119, the disclosure of which is incorporated by reference in its entirety.

### BACKGROUND OF THE INVENTION

1. Field of the Invention

This invention relates to a plasma display panel (hereinafter referred to as “PDP”) and a manufacturing method thereof, and more particularly, relates to a PDP having a structure in which a substrate on the front-face side and a substrate on the back-face side are aligned face to face with each other and the peripheral portion thereof is sealed by a sealing material, and a manufacturing method for such a PDP.

2. Description of the Related Art

An AC drive three-electrode face discharge type PDP has been known as a conventional PDP. This PDP has a structure in which desired constituent elements such as electrodes, dielectric layers, phosphor layers and barrier ribs are formed on glass substrates on the front-face side and the back-face side, and these glass substrates on the front-face side and the back-face side are bonded to each other. The sealing process of the front-side substrate and the back-side substrate is carried out through the following processes: a glass sealing material containing low-melting point glass is applied to the peripheral portion of the substrates and the glass sealing material is fused and anchored by heat so that the substrates are bonded to each other. In this bonding process, a vacuum-exhausting process is carried out on the inside of the panel through a vent hole formed in the substrate on the back-face side into a low pressure so that, after impurity gases have been once removed, an inert gas such as Ne and Xe is then sealed therein as a discharge gas. In general, this process is referred to as a sealing exhaust process.

The structure of the barrier ribs of a PDP includes, for example, a linear barrier-rib structure (referred to as a stripe rib structure) in which a discharge space is separated only in the row direction by forming a plurality of barrier ribs in the column direction, and a closed-type barrier-rib structure (referred to as a box rib structure, a waffle rib structure, a mesh rib structure, etc.) in which the discharge space is divided into respective cells by forming barrier ribs in the row direction and barrier ribs in the column direction (see Japanese Unexamined Patent Publication No. HEI11-213896). In recent years, in order to improve the light-emitting brightness and achieve pixels with high precision, there has been a strong demand for PDPs having the closed-type barrier-rib structure.

As described above, in the sealing exhaust process of the PDP, impurity gases need to be removed from the inside of the panel by carrying out a vacuum exhausting operation through a vent hole. In this case, the PDP having the closed-type structure of barrier ribs has a smaller ventilation conductance in the panel in comparison with the PDP having the linear structure of barrier ribs, resulting in a difficulty in exhausting the impurity gases. When the removal of the impurity gases is insufficient, the characteristics of the panel deteriorate. More specifically, there are a reduction in the brightness and variations in the voltage due to degradation of the phosphor, and display irregularities in the panel tend to be caused.

For this reason, there has been a demand for a technique that can ensure the vent path in the sealing exhaust process of a PDP having the closed-type barrier-rib structure, by using a simple structure.

### SUMMARY OF THE INVENTION

The present invention, which has been devised to solve the above-mentioned problems, has a structure in which, when carrying out a sealing exhaust process on the panel, a spacer having a softening point higher than that of the sealing material is placed between substrates so that, after impurity gases inside the panel have been discharged with a vent path being ensured by the spacer, the spacer is softened to serve as a bonding material, thereby, at the time of sealing the substrates, ensuring the vent path and improving the adhesion of the substrates.

The present invention provides a plasma display panel comprising: a pair of substrates in which one of substrates on which closed-type barrier ribs for dividing a discharge space into respective cells are formed is aligned face to face with the other substrate, the peripheral portion of the substrates being sealed by a sealing material that is softened by applying heat thereto; and a spacer that is softened at a temperature higher than the softening temperature of the sealing material at the time of applying heat during sealing the substrates and used for bonding top portions of the barrier ribs and the other substrate to each other, wherein the spacer is placed between the top portion of the barrier ribs formed on the one of the substrates and the other substrate.

In accordance with the present invention, in the PDP having closed-type barrier ribs, even when, at the time of carrying out a sealing exhaust process on the panel, the sealing material is softened and deformed so that the front-face side substrate and the back-face side substrate are press-bonded to each other under an atmospheric pressure, since the spacer, which ensures a gap between the two substrates, is placed, a sufficient vent path is ensured in the panel, and impurity gases are sufficiently removed. With this arrangement, characteristics of the panel thus manufactured, such as a lifetime thereof, can be enhanced, and the yield of the panel can also be improved. In this structure, after the impurity gases have been sufficiently discharged, by further heating the spacer to be softened and deformed so that the gap between the front-side substrate and the back-side substrate is narrowed, it becomes possible to prevent a problem of crosstalk due to discharging. Moreover, since the spacer is fused so that the front-side substrate and the back-side substrate are bonded to each other, it is possible to reduce a panel vibration sound that is generated when an alternate voltage with a high frequency is applied thereto in driving the panel.

### BRIEF DESCRIPTION OF THE DRAWINGS

FIGS. 1(a) and 1(b) are explanatory diagrams that show a structure of a PDP in accordance with an embodiment of the present invention;

FIG. 2 is an explanatory diagram that shows a first embodiment of a spacer layout of the PDP in accordance with the present invention;

FIGS. 3(a) to 3(c) are explanatory diagrams that show a sealing exhaust process to be carried out on a panel in accordance with the first embodiment of the present invention;

FIG. 4 is an explanatory diagram that shows a second embodiment of a spacer layout of the PDP in accordance with the present invention;

FIG. 5 is an explanatory diagram that shows a third embodiment of a spacer layout of the PDP in accordance with the present invention;

FIG. 6 is an explanatory diagram that shows a fourth embodiment of a spacer layout of the PDP in accordance with the present invention;

FIG. 7 is an explanatory diagram that shows a fifth embodiment of a spacer layout of the PDP in accordance with the present invention;

FIG. 8 is an explanatory diagram that shows a sixth embodiment of a spacer layout of the PDP in accordance with the present invention; and

FIG. 9 is an explanatory diagram that shows a seventh embodiment of a spacer layout of the PDP in accordance with the present invention.

### DETAILED DESCRIPTION OF THE INVENTION

In the present invention, with respect to one of the substrates and the other substrate, substrates made from materials such as glass, quartz and ceramics and those substrates, prepared by forming desired constituent elements such as electrodes, an insulating film, a dielectric layer, a protective film and the like on these substrates, may be used.

The above-mentioned electrodes can be formed by using various materials and methods known in the corresponding field. With respect to materials used for the electrodes, for example, transparent conductive materials such as ITO and SnO₂ and metal conductive materials such as Ag, Au, Al, Cu and Cr may be used. With respect to the formation method of the electrodes, various methods known in the corresponding field may be used. For example, a thick-film forming technique such as printing may be used, or a thin-film forming technique using a physical deposition method or a chemical deposition method may be used. With respect to the thick-film forming technique, for example, a screen printing method is listed. In the thin-film forming technique, the physical deposition method includes a vapor deposition method, a sputtering method, etc. The chemical deposition method includes a thermal CVD method and a photo CVD method, and a plasma CVD method.

In the present invention, any closed-type barrier ribs may be used as long as they divide a discharge space into respective cells. These closed-type barrier ribs include barrier ribs of a lattice-shaped structure configured by barrier ribs formed on a panel surface in the row direction and barrier ribs formed thereon in the column direction, that is, a so-called box-rib structure, waffle-rib structure, mesh-rib structure, etc. In this case, the barrier ribs in the row direction and the barrier ribs in the column direction are not necessarily required to be made orthogonal to each other, as long as they are made to cross each other at a desired angle. The height of the barrier ribs in the row direction and the height of the barrier ribs in the column direction are not necessarily made the same, and may be set to different heights. In addition to these, the closed-type barrier ribs of the present invention may include barrier ribs of a so-called meander rib structure in which by forming barrier ribs in a winding pattern, the discharge space is virtually divided into respective cells.

The barrier ribs are preferably prepared as barrier ribs of the closed type, with the heights of the top portions of the barrier ribs being uniformly adjusted, which are formed by a method such as sand blasting and etching; however, not necessarily limited to these, the present invention may be applied to barrier ribs formed by another method, or to barrier ribs having irregular heights at top portions of the barrier ribs.

With respect to the sealing material, any material may be used as long as it can seal the peripheral portion of the substrates upon softened by application of heat. Various sealing materials known in the corresponding field may be applied as the sealing material. The sealing process of the substrates may be carried out, for example, through the following processes: a glass paste containing, for example, low-melting point glass frit, a binder resin, a solvent etc., is used as the sealing material, and by applying this glass paste to a portion to be sealed on the periphery of the substrate on the back-face side, and after this has been temporarily fired to remove the binder resin components, the back-side substrate and the front-side substrate are aligned face to face with each other, and put into a heating furnace to be subjected to a predetermined heating process so that the sealing material is fused and anchored. At the time of the sealing process, impurity gases are discharged from the discharge space between the substrates. With respect to the low melting-point glass frit to be used as the sealing material, e.g., PbO.B₂O₃-based glass may be used.

In the present invention, a spacer, which is softened at a temperature higher than the softening temperature of the sealing material in applying heat at the time of sealing the substrates, and used for bonding top portions of the barrier ribs and the other substrate to each other, is placed between the top portions of the barrier ribs formed on one of the substrates and the other substrate.

It is only necessary for the spacer to be placed on the top portion of the barrier ribs. This mounting position may be determined at any desired position as long as the position makes it possible to provide a sufficient vent path at the time of carrying out a sealing exhaust process on the panel. For example, in the case of cells having a rectangular shape on the plan view, separated by barrier ribs in the row direction and barrier ribs in the column direction, this mounting position may be determined at top portions of barrier ribs corresponding to four corners of each cell. Alternatively, the mounting position may be determined at top portions of barrier ribs corresponding to four corners of cells forming one pixel having a set of an R cell on which a red phosphor layer is formed, a G cell on which a green phosphor layer is formed and a B cell on which a blue phosphor layer is formed. Alternatively, it may be determined at top portions of barrier ribs in the row direction or top portions of barrier ribs in the column direction. In this manner, the mounting position of the spacer may be appropriately determined at any position as long as it provides a sufficient vent path at the time of carrying out a sealing exhaust process on the panel.

The spacer is prepared as a material formed by temporarily firing glass paste containing glass frit, a binder resin, a solvent, etc. With respect to the glass frit, the binder resin, the solvent, etc. as materials for the spacer, various materials known in the corresponding field may be applied. The spacer may be prepared as any material as long as it is softened at a temperature higher than the softening point of the sealing material in heating at the time of sealing the substrates. Those materials having a softening point higher than that of the sealing material by 20 to 50° C., more preferably, by about 40° C., are preferably used as the spacer. In the case where the above-mentioned material, formed by temporarily firing glass paste containing glass frit, a binder resin, a solvent, etc., is used as the spacer, by heating the temporarily fired glass material so as to be fused, the top portions of the barrier ribs formed on one of substrates and the other substrate can be bonded and anchored onto each other.

The softening point of the spacer can be adjusted to an appropriate softening point by adjusting the components of the glass frit, or by blending a filler into the glass paste.

For example, when the glass frit for the sealing material is, e.g. PbO.B₂O₃-based glass, the glass frit for the spacer is prepared as, e.g. a non-lead based (Bi-based, ZnO-based) glass so that the softening point of the spacer can be made higher than that of the sealing material by about 20 to 50° C.

Alternately, by blending a filler, such as TiO₂, SiO₂ and Al₂O₃, into the spacer, the softening point of the spacer can be made higher than that of the sealing material by about 20 to 50° C.

In the above-mentioned structure, the spacer may be formed into a desired shape at the time of the temporarily firing process; however, it is preferable to form the spacer into a shape narrower than the width of the top portion of each of the barrier ribs, and also to place it within a range narrower than the width of the top portion of each of the barrier ribs. In the case where the spacer is formed in the range narrower than the width of the top portion of each of the barrier ribs in this manner, even if the spacer is softened and deformed to be spread, it does not reach the phosphor layer formed at the opening of the cell, thereby making it possible to prevent an adverse effect on the light emission of the phosphor layer in the vicinity of the top portion of the barrier ribs.

The present invention also relates to a method of manufacturing a plasma display panel comprising the steps of: aligning one of substrates on which closed-type barrier ribs used for dividing a discharge space into respective cells are formed and the other substrate face to face with each other; placing a sealing material that is softened upon application of heat on the peripheral portion of the substrates; placing a spacer that is softened at a temperature higher than the softening point of the sealing material at the time of heating during sealing the substrates to bond the top portion of the barrier ribs and the other substrate to each other, between the top portion of the barrier ribs formed on one of substrates and the other substrate; and, when discharging impurity gases from the discharge space between the substrates at the time of sealing one of the substrates and the other substrate, heating the sealing material to a temperature at which it is softened, and after impurity gases have been discharged, further heating the substrates so as to soften the spacer.

Referring to the accompanying drawings, in the following description, embodiments of the present invention will be discussed in detail. However, the present invention is not limited thereto, and various modifications may be made therein.

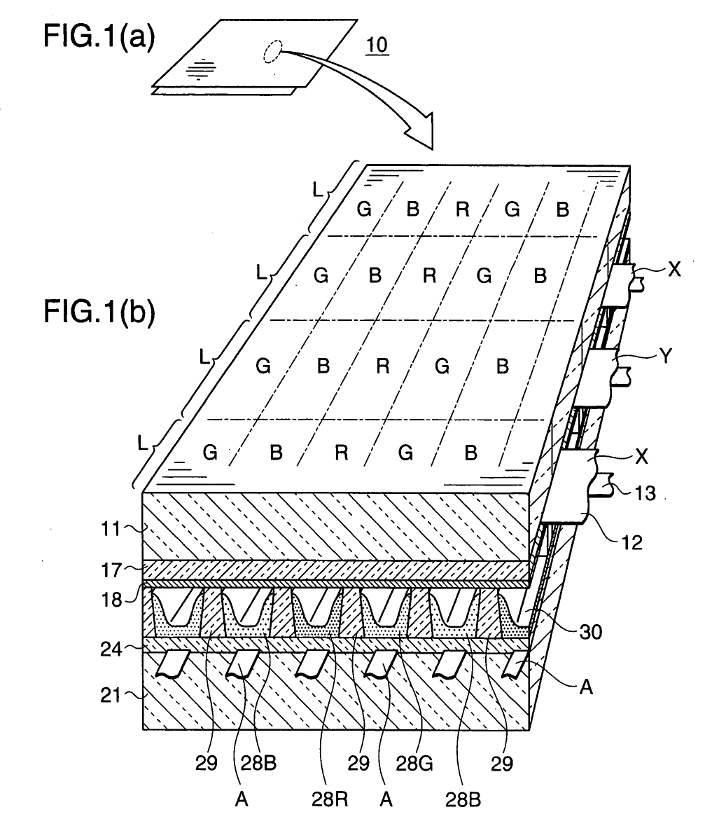

FIGS. 1(a) and 1(b) are explanatory diagrams that show a structure of a PDP in accordance with an embodiment of the present invention. FIG. 1(a) shows the entire structure of the PDP, and FIG. 1(b) is a partially exploded perspective view of the PDP. This PDP is a three-electrode face discharge type PDP of an AC drive type for color display.

A PDP 10 is constituted by a substrate 11 on the front-face side on which constituent elements that provide functions as the PDP are formed and a substrate 21 on the back-face side. With respect to the substrate 11 on the front-face side and the substrate 21 on the back-face side, glass substrates are used; however, in addition to the glass substrates, for example, quartz substrates and ceramics substrates may be used.

Display electrodes X and display electrodes Y are placed with equal intervals in the horizontal direction on the inner side face of the substrate 11 on the front-face side. All the intermediate portions between the adjacent display electrodes X and display electrodes Y form display lines L. Each of the display electrodes X and Y is constituted by a transparent electrode 12 with a wide width, made of, e.g. ITO, SnO₂, and a bus electrode 13 with a narrow width, made of metal, such as Ag, Au, Al, Cu, Cr or a laminated body thereof (for example, Cr—Cu—Cr laminated structure). With respect to the display electrodes X and Y, in the case of Ag and Au, a thick-film forming technique such as screen printing may be used, and in the case of other materials, a thin-film forming technique, such as a vapor deposition method and a sputtering method, and an etching technique may be used, so that the display electrodes having a desired number, thickness, width and intervals can be formed.

Here, in the present PDP, a PDP having a so-called ALIS structure, in which the display electrodes X and the display electrodes Y are placed with equal intervals, with all the intermediate portions between the adjacent display electrodes X and display electrodes Y forming display lines L, is shown; however, the present invention may be applied even to a PDP having a structure in which paired display electrodes X and Y are placed with a gap (non-discharging gap) causing no discharge.

A dielectric layer 17 is formed on the display electrodes X and Y in a manner so as to cover the display electrodes X and Y. The dielectric layer 17 is formed by applying a glass paste made from glass frit, a binder resin and a solvent onto a substrate 11 on the front-face side through a screen printing method and by firing the resulting substrate. The dielectric layer 17 may be prepared by forming a SiO₂ film through a plasma CVD method.

A protective film 18, used for protecting the dielectric layer 17 from damage caused by collision of ions generated by a discharge in displaying, is formed on the dielectric layer 17. This protective film is made from MgO. The protective film may be formed by using a known thin-film forming process in the corresponding field, such as an electron beam vapor deposition method and a sputtering method.

A plurality of address electrodes A are formed on the inner side face of the substrate 21 on the back-face side in a direction crossing the display electrodes X and Y when viewed from above, and a dielectric layer 24 is formed so as to cover the address electrodes A. Each of the address electrodes A is used for generating an address discharge to select a light-emitting cell at an intersection with the Y electrode, and formed into a three-layer structure of Cr—Cu—Cr. The address electrodes A may be formed by using another material such as Ag, Au, Al, Cu, or Cr. In the same manner as the display electrodes X and Y, with respect to the address electrodes A, in the case of Ag and Au, a thick-film forming technique such as screen printing may be used, and in the case of other materials, a thin-film forming technique such as a vapor deposition method and a sputtering method, and an etching technique may be used, so that the address electrodes having a desired number, thickness, width and intervals can be formed. The dielectric layer 24 may be formed by using the same material and the same method as the dielectric layer 17.

A plurality of barrier ribs 29 having a lattice pattern, which divide a discharge space into respective cells, are formed on the dielectric layer 24 between the adjacent address electrodes A. The barrier ribs 29 having the lattice pattern are also referred to as box ribs, waffle ribs and mesh-shaped ribs. The barrier ribs 29 may be formed by using a method such as a sand blasting method, a photosensitive paste method and an etching method. For example, in the sand blasting method, a glass paste, made from glass frit, a binder resin, a solvent, etc., is applied onto the dielectric layer 24 and dried thereon, and cutting particles are then blasted onto the glass paste layer, with a cutting mask having openings corresponding to the pattern of the barrier ribs attached thereto, so that the glass paste layer exposed to the openings of the mask are cut, and the resulting glass paste layer is then fired so that barrier ribs are formed. Moreover, in the photosensitive paste method, instead of the cutting process by the use of cutting particles, a photosensitive resin is used as the binder resin, and after carrying out exposing and developing processes by the use of a mask, the resulting layer is fired so that the barrier ribs are formed. In the case of the etching method, in the same manner as the sand blasting method, a glass paste is applied onto the dielectric layer and dried thereon, and an etching solution is then blown onto the surface thereof, with a mask having openings corresponding to the pattern of the barrier ribs attached thereto, so that the glass layer exposed to the openings of the mask are etched; thus, barrier ribs are formed.

Phosphor layers of 28R, 28G and 28B having red (R), green (G) and blue (B) colors respectively are formed on side faces and a bottom face of each of cells having a rectangular shape when viewed from above, which is surrounded by the barrier ribs 29 having a lattice pattern. The phosphor layers 28R, 28G and 28B are formed through processes in which: a phosphor paste containing phosphor powder, a binder resin and a solvent is applied to the inside of each cell surrounded by the barrier ribs 29 by using a screen printing method or a method using a dispenser, and after repeating this process for each of the colors, the resulting layers are fired. These phosphor layers 28R, 28G and 28B may also be formed through a photolithographic technique by using a sheet-shaped phosphor layer material (so-called green sheet) containing phosphor powder, a photosensitive material and a binder resin. In this case, a sheet having a desired color is affixed to the entire face of a display area on the substrate, and this is exposed and developed, and by repeating these processes for each of the colors, the phosphor layers of the respective colors can be formed in the corresponding cell.

A PDP is manufactured through the following processes: the above-mentioned substrate 11 on the front-face side and substrate 21 on the back-face side are placed face to face with each other so that the display electrodes X and Y cross the address electrodes A, and the peripheral portion is sealed with a discharge space 30 surrounded by the barrier ribs 29 being filled with a discharge gas containing Xe and Ne in a mixed state. In this PDP, the discharge space 30, located each of the intersections between the display electrodes X and Y and the address electrodes A, forms one cell (unit light-emitting area) that is the minimum unit for display. One pixel is configured by three cells of R, G and B.

In the present invention, a spacer is placed between the top portion of the barrier ribs formed on the substrate on the back-face side and the substrate on the front-face side. In the following description, embodiments relating to the layout of the spacer will be discussed.

### First Embodiment

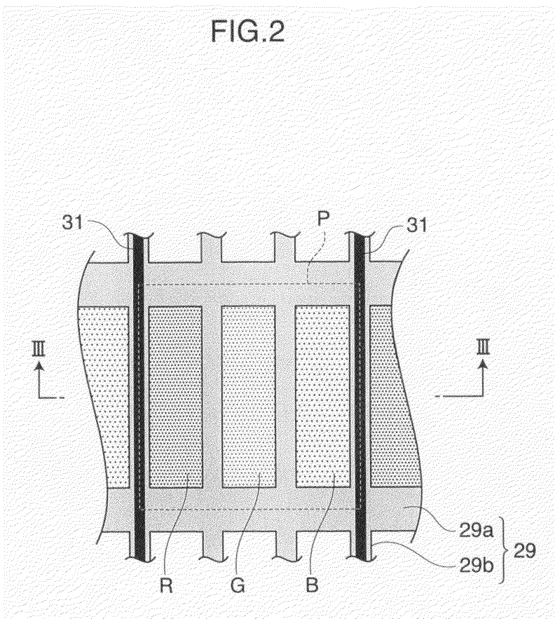

FIG. 2 is an explanatory diagram that shows a first embodiment of the spacer layout of a PDP in accordance with the present invention. This figure shows a state in which the PDP is viewed from above.

In this figure, a portion P surrounded by a broken line indicates cells corresponding to one pixel, configured by three cells of R, G and B.

As described above, the barrier ribs 29, configured by barrier ribs 29a in the row direction that are formed in the row direction with respect to the panel face and barrier ribs 29b in the column direction that are formed in the column direction with respect thereto, are formed on the substrate on the back-face side.

The lattice-shaped barrier ribs 29 are formed by using a known method in the corresponding field, such as sand blasting and etching. In the present invention, the lattice-shaped barrier ribs have been exemplified; however, any barrier ribs may be used as long as they are closed-type barrier ribs with the heights of the top portions of the barrier ribs being uniformly adjusted, and the same effects are available.

Each spacer 31, which is softened at a temperature higher than the softening point of the sealing material when carrying out a sealing exhaust process on the panel, and used for bonding the top portion of the barrier ribs and the substrate on the front-face side to each other is placed between the top portion of the lattice-shaped barrier ribs 29 and the substrate on the front-face side.

In the present embodiment, the spacers 31 are continuously formed on the barrier ribs 29b in the column direction positioned at each of borders of cells P corresponding to one pixel, along the barrier ribs 29b in the column direction. In other words, these are placed every one per three barrier ribs 29b in the column direction. In this manner, the spacers 31 are placed at least one or more positions with respect to one pixel. Here, the spacers 31 are continuously placed along the barrier ribs 29b in the column direction; however, these are not necessarily required to be placed continuously, and may be partially placed intermittently.

Each spacer 31 is formed to have a thickness capable of ensuring a space of about 20 μm or more between the substrate on the front-face side and the top portion of the barrier ribs. The spacer 31 is formed by using a material that has a softening point higher than that of a sealing material applied to the periphery of the substrates when carrying out a sealing exhaust process on the panel and also has a softening point lower than that of a glass material contained in the barrier ribs and the dielectric layer.

More specifically, when carrying out the sealing process of the panel, the temperature which causes the sealing material to soften so that the distance between the substrate on the front-face side and the substrate on the back-face side becomes narrower is about 410° C. Therefore, each spacer 31 is formed by using a material that is not softened and deformed at a temperature about 410° C. Moreover, the softening point of the glass material contained in the barrier ribs 29 is about 550° C. For this reason, the spacer 31 is formed by using a material that is softened and deformed at a temperature about 550° C. or less. Therefore, most preferably, it is formed by using a material that has a softening point higher than that of the sealing material by 20 to 50° C., that is, a softening point in a range of about 430 to 460° C. This adjustment of the softening point is carried out by appropriately selecting the material for the glass frit contained in the spacer 31, or by blending an appropriate filler into the spacer 31.

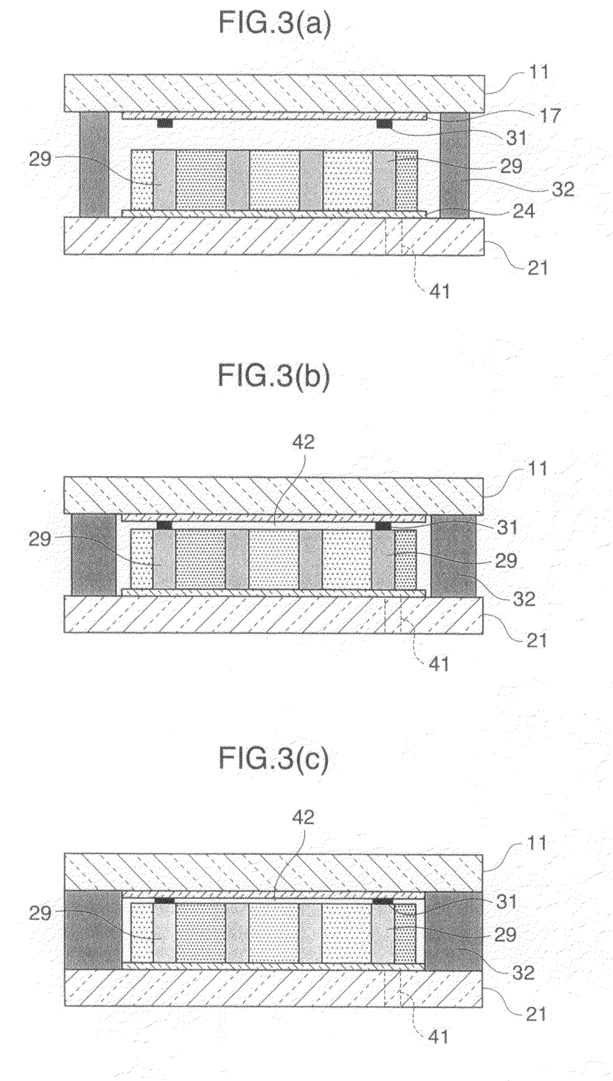

FIGS. 3(a) to 3(c) are explanatory diagrams that show the sealing exhaust process of the panel. These figures are cross-sectional views taken along line III-III in FIG. 2.

Prior to the sealing exhaust process, each spacer 31 is formed at a position where it is made in contact with the top portion of each of the barrier ribs 29 of the substrate 11 on the front-face side on which layers up to the dielectric layer 17 have been formed.

Each spacer 31 is formed by applying a glass paste containing glass frit, a binder resin and a solvent through a screen printing method, a dispense method, etc., and by temporarily firing the resulting layer. The amount of the glass paste to be applied to form the spacer 31 is adjusted so as to allow the spacer 31 to have a thickness of about 20 μm after having been temporarily fired to eliminate resin components. With respect to the glass frit of the spacer 31, a non-lead based glass, such as Bi₂O₃ (Bi-based) glass and ZnO-based glass, for example, YPV3-4003 made by Yamato Electronic Co., Ltd., is used. Thus, the softening point of the spacer is kept higher than that of the sealing material, by 20 to 50° C.

Simultaneously with the above-mentioned process, or before or after the above-mentioned process, a glass paste containing glass frit, a binder resin, a solvent, etc., is applied to the peripheral portion of the substrate 11 on the front-face side by using a method such as a screen printing method and a dispense method, and by temporarily firing this, a sealing material 32 is preliminarily formed on the peripheral portion of the substrate 21 on the front-face side. With respect to the glass frit for the sealing material 32, PbO.B₂O₃-based glass, for example, LS-0206 made by Nippon Electric Glass Co., Ltd., is used.

In order to simplify the process, the formation processes of the spacer 31 and the sealing material 32 are preferably carried out simultaneously. In other words, the glass paste for the spacer is applied, and the glass paste for the sealing material is applied before or after this process, and the temporarily firing process is then carried out simultaneously.

With respect to the materials for the spacer 31 and the sealing material 32 and the method of the temporarily firing process, materials and methods known in the corresponding field may be used. The material for the spacer 31 is basically the same as the sealing material; however, those materials having a softening point higher than that of the sealing material by about 20 to 50° C. are used as described earlier.

Thereafter, a protective film is formed on an area corresponding to the display area of the substrate 11 on the front-face side. The protective film is omitted from the figure.

In the present embodiment, the spacer and the sealing material are formed on the substrate on the front-face side; however, the spacer and the sealing material may be formed on any of the substrates on the front-face side and the back-face side. In other words, the spacer may be formed on the substrate on the front-face side, with the sealing material being formed on the substrate on the back-face side, or vice versa, or both of the spacer and the sealing material may be formed on the substrate on the back-face side. In the case where the spacers are formed on the substrate on the back-face side, each spacer is formed on the top portion of each of the barrier ribs.

Moreover, the substrate 11 on the front-face side on which the spacers 31 and the sealing material 32 are formed and the substrate 21 on the back-face side on which constituent elements, such as the phosphor layers, are formed are position-adjusted and aligned face to face with each other, and the periphery of the substrates are secured by a spring member having a high temperature resistance, such as a clip made of Inconel (registered trademark), and this is transported into a heating furnace, and subjected to the sealing exhaust process (see FIG. 3(a)).

In the sealing exhaust process, the substrate 11 on the front-face side and the substrate 21 on the back-face side, which have been position-adjusted, are heated, and a vacuum exhausting process is carried out through the vent hole 41 so that, while moisture and carbon dioxide adhering to the surface of the protective film, as well as impurity gases adhering to the inside of the panel, are being discharged, the substrates are heated to a temperature at which the sealing material 32 on the periphery of the panel is softened and deformed. At this temperature, the vent space, formed through the thickness of the spacers 31, serves as a vent path 42 between the substrate 11 on the front-face side and the substrate 21 on the back-face side so that an exhaust path for impurity gases is ensured. The exhausting process is carried out in this state, and the impurity gases inside the panel are sufficiently discharged (see FIG. 3(b)).

Thereafter, the substrates are further heated so that each spacer 31 is softened and deformed so that the gap between the substrate 11 on the front-face side and the substrate 21 on the back-face side is narrowed, and the substrate 11 on the front-face side and the substrate 21 on the back-face side are bonded to each other by the spacers 31 (see FIG. 3(c)).

A discharge gas is then sealed in the discharge space in the panel so that a display panel is manufactured. At this time, the gap 43 between the substrate 11 on the front-face side and the substrate 21 on the back-face side is formed into a gap of about 5 μm or less in order to prevent crosstalk due to discharging.

Each spacer 31 is formed within a range narrower than the width of the top portions of the barrier ribs. In the case when the spacer is formed in this manner, even if the spacer is softened to be squashed, the softened spacer does not reach the opening of the cell, and is prevented from giving adverse effects on the light emission of the phosphor layer in the vicinity of the top portion of the barrier ribs.

In accordance with the present embodiment, each spacer, which is not softened and deformed even at a temperature that allows the sealing material to soften, is preliminarily formed at a position where the spacer is made in contact with the top portion of the barrier ribs, and a gap is kept between the substrate on the front-face side and the substrate on the back-face side by the spacer even at a temperature that makes the sealing material soften, so that a vent path inside the panel can be ensured. After impurity gases inside the panel have been discharged sufficiently in this state, the substrates are further heated to a higher temperature so that the spacer is softened and squashed. At this temperature, only the spacer is softened while the barrier ribs are not softened, so that the gap between the substrate on the front-face side and the substrate on the back-face side can be virtually eliminated. Since no gap exists between the substrate on the front-face side and the substrate on the back-face side in the final structure, no crosstalk due to discharging is generated between the adjacent cells.

Each spacer is formed within a range narrower than the width of the top portion of the barrier ribs; therefore, even when the spacer is softened to be squashed, the softened spacer does not reach the opening of the cell, and is prevented from giving adverse effects on the light emission of the phosphor layer in the vicinity of the top portion of the barrier ribs.

### Second Embodiment

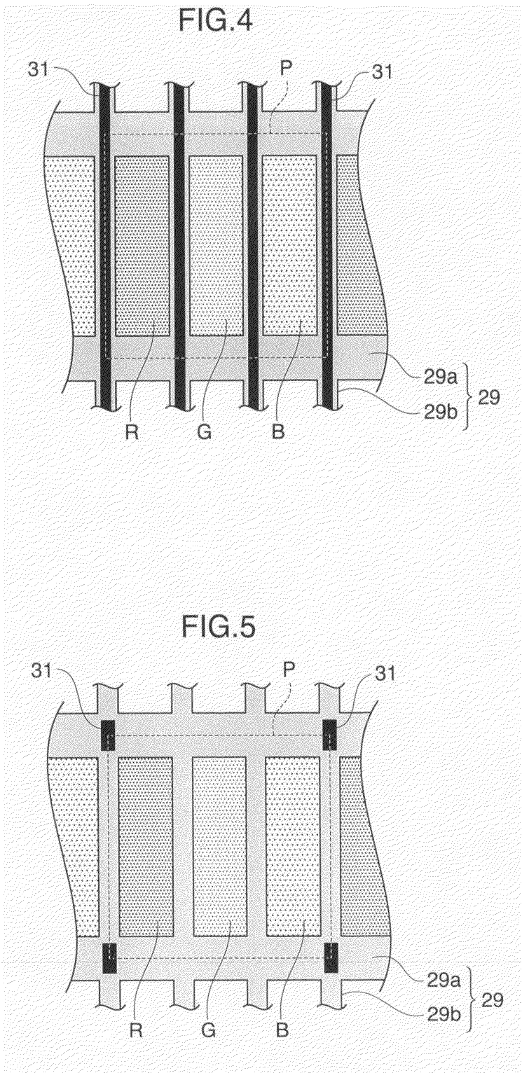

FIG. 4 is an explanatory diagram that shows a second embodiment of the layout of spacers of a PDP in accordance with the present invention.

A portion P indicates cells corresponding to one pixel configured by three cells of R, G and B.

In the present embodiment, the spacers 31 are formed continuously along the barrier ribs 29b in the column direction on the entire barrier ribs 29b in the column direction.

### Third Embodiment

FIG. 5 is an explanatory diagram that shows a third embodiment of the layout of spacers of a PDP in accordance with the present invention.

A portion P indicates cells corresponding to one pixel configured by three cells of R, G and B.

In the present embodiment, the spacers 31 are formed on crossing points between the barrier ribs 29a in the row direction and the barrier ribs 29b in the column direction that form cells corresponding to one pixel, in a dot format.

### Fourth Embodiment

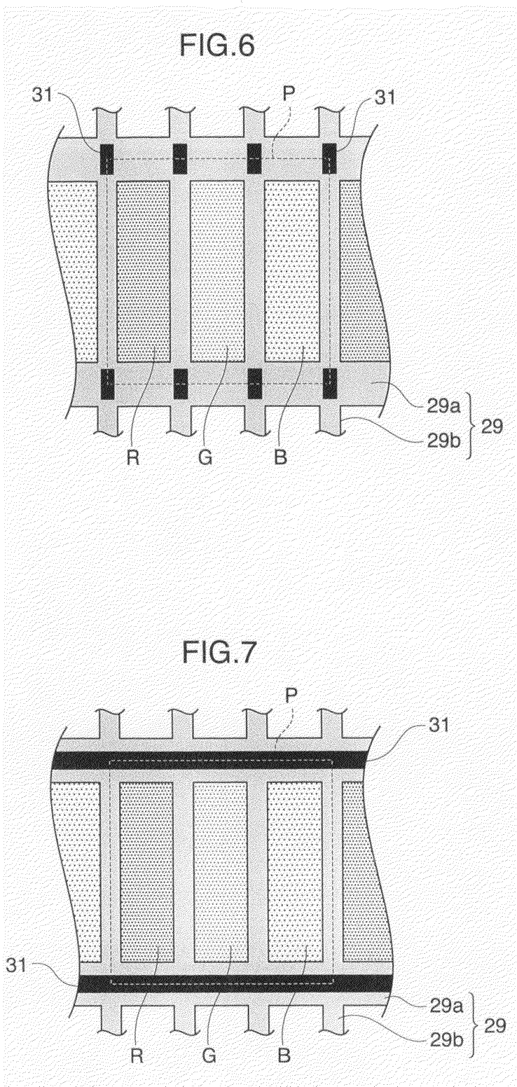

FIG. 6 is an explanatory diagram that shows a fourth embodiment of the layout of spacers of a PDP in accordance with the present invention.

A portion P indicates cells corresponding to one pixel configured by three cells of R, G and B.

In the present embodiment, the spacers 31 are formed on all the crossing points between the barrier ribs 29a in the row direction and the barrier ribs 29b in the column direction in a dot format.

### Fifth Embodiment

FIG. 7 is an explanatory diagram that shows a fifth embodiment of the layout of spacers of a PDP in accordance with the present invention.

A portion P indicates cells corresponding to one pixel configured by three cells of R, G and B.

In the present embodiment, the spacers 31 are continuously formed on all the barrier ribs 29a in the row direction along the barrier ribs 29a in the row direction.

### Sixth Embodiment

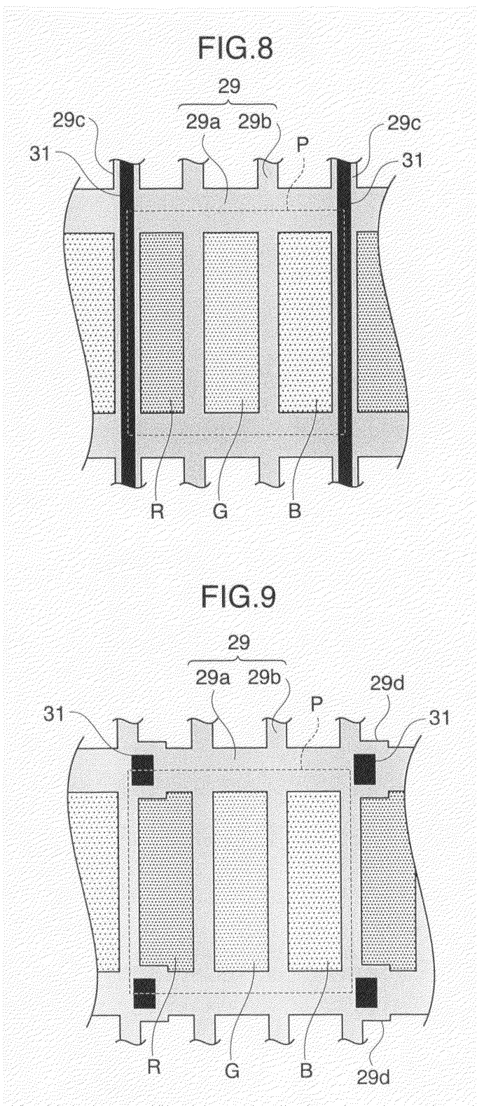

FIG. 8 is an explanatory diagram that shows a sixth embodiment of the layout of spacers of a PDP in accordance with the present invention.

A portion P indicates cells corresponding to one pixel configured by three cells of R, G and B.

In the present embodiment, the spacers 31 are continuously placed on the barrier ribs 29b in the column direction positioned at each of borders of cells P corresponding to one pixel, along the barrier ribs 29b in the column direction. In other words, these are placed every one per three barrier ribs 29b in the column direction. In this point, the structure is the same as that of the first embodiment; however, the width in the row direction of barrier ribs 29c on which the spacers 31 are placed is made wider. In other words, the area of the R cells is narrowed by a portion corresponding to the widened portion in the row direction of the barrier ribs 29c.

The width of the barrier ribs 29c is widened so that, even when the spacer 31 is softened and deformed to be spread, the spacer 31 is prevented from spreading onto the phosphor layer on the cell opening portion.

Here, the area of the R cells is narrowed by a portion corresponding to the widened portion in the row direction of the barrier ribs 29c; however, generally in the PDP, the red light-emitting area is made smaller because of reasons such as an adjustment in white balance, therefore, even when the area of the R cells is made narrower, no adverse effect is given on the white balance.

### Seventh Embodiment

FIG. 9 is an explanatory diagram that shows a seventh embodiment of the layout of spacers of a PDP in accordance with the present invention.

A portion P indicates cells corresponding to one pixel configured by three cells of R, G and B.

In the present embodiment, the spacers 31 are formed on crossing points between the barrier ribs 29a in the row direction and the barrier ribs 29b in the column direction that form cells corresponding to one pixel, in a dot format. In this point, the structure is the same as that of the third embodiment; however, the widths in the column direction as well as in the row direction of barrier ribs 29d on which the spacers 31 are placed are made wider. In other words, the area of the R cells is narrowed by portions corresponding to the widened portions in the column direction as well as in the row direction of the barrier ribs 29d. In this embodiment, both of the widths in the column direction and in the row direction of the barrier ribs 29d are widened; however, either one of the widths in the column direction and in the row direction may be widened.

In the same manner as the sixth embodiment, the widths of the barrier ribs 29d are widened, so that, even when the spacer 31 is softened and deformed to be spread, the spacer 31 is prevented from spreading onto the phosphor layer on the cell opening portion. Although the area of the R cells is narrowed by portions corresponding to the widened portions in the column direction and in the row direction of the barrier ribs 29d, no adverse effect is given on the white balance, as in the sixth embodiment.

In order to prevent the spacer 31 from spreading onto the cell opening portion even when the spacer 31 is softened, the area of the softened spacer 31 is made equal to the area of the crossing portion between the barrier ribs.

For example, in the case where spacers 31 are formed at crossing portions of the lattice-shaped barrier ribs (box ribs) 29 in a dot format, suppose that each spacer 31 prior to being softened and deformed has a size of 60 μm×60 μm with a thickness of 20 μm. Supposing that the spacer 31 is softened and deformed to have a thickness of 5 μm, the plane area occupied by the spacer 31, calculated based on the volume of the spacer 31, is 120 μm×120 μm. Therefore, the crossing portion between the barrier ribs is made to have an area wider than this area.

As described above, in accordance with the present invention, a spacer, which ensures a gap between the substrate on the front-face side and the substrate on the back-face side even after the sealing material has been softened and deformed in a sealing exhaust process of the panel, is placed so that the vent path inside the panel is ensured; thus, impurity gases can be sufficiently removed. With this arrangement, characteristics of the panel thus manufactured, such as a lifetime thereof, can be enhanced, and the yield of the panel can also be improved.

In this structure, by further heating the spacer to be softened and deformed, after the impurity gases have been sufficiently discharged, so that the gap between the front-face side substrate and the back-face side substrate is narrowed, it becomes possible to prevent a problem of crosstalk due to discharging. Moreover, since the front-face side substrate and the back-face side substrate are bonded to each other by using the spacer, it is possible to improve the panel strength and also prevent panel vibrations at the time of driving the panel. In this structure, the spacer is formed within a range narrower than the width of the top portion of the barrier ribs; thus, even when the spacer is softened and deformed to be spread, the spacer is prevented from spreading onto the phosphor layer on the cell opening portion, and consequently prevented from giving adverse effects on the light emission of the phosphor layer in the vicinity of the top portion of the barrier ribs. With this arrangement, it becomes possible to desirably carry out an exhausting process in the panel and a filling process of a discharge gas into the panel, in a PDP having a closed-type barrier-rib structure, and consequently to improve the quality of the PDP.

What is claimed is:

1. A plasma display panel comprising:
a pair of substrates in which one of substrates on which closed-type barrier ribs for dividing a discharge space into respective cells are formed is aligned face to face with the other substrate, the peripheral portion of the substrates being sealed by a sealing material that is softened by applying heat thereto; and
a spacer that is softened at a temperature higher than the softening temperature of the sealing material at the time of applying heat during sealing the substrates and used for bonding top portions of the barrier ribs and the other substrate to each other,
wherein the spacer is placed between the top portion of the barrier ribs formed on the one of the substrates and the other substrate.

2. The plasma display panel according to claim 1, wherein the spacer is placed within a range narrower than the width of the top portion of the barrier ribs.

3. The plasma display panel according to claim 1, wherein the spacers are continuously formed on the barrier ribs in the column direction positioned at each of borders of cells corresponding to one pixel, along the barrier ribs in the column direction.

4. The plasma display panel according to claim 1, wherein the spacers are formed continuously along the barrier ribs in the column direction on the entire barrier ribs in the column direction.

5. The plasma display panel according to claim 1, wherein the spacers are formed on crossing points between the barrier ribs in the row direction and the barrier ribs in the column direction that form cells corresponding to one pixel, in a dot format.

6. The plasma display panel according to claim 1, wherein the spacers are formed on all the crossing points between the barrier ribs in the row direction and the barrier ribs in the column direction in a dot format.

7. The plasma display panel according to claim 1, wherein the spacers are continuously formed on all the barrier ribs in the row direction along the barrier ribs in the row direction.

8. The plasma display panel according to claim 1, wherein the spacers are continuously placed on the barrier ribs in the column direction positioned at each of borders of cells corresponding to one pixel, along the barrier ribs in the column direction.

9. The plasma display panel according to claim 1, wherein the widths of the barrier ribs in crossing points between the barrier ribs in the row direction and the barrier ribs in the column direction that form cells corresponding to one pixel are made wider than the other part of the barrier ribs in the column direction and the row direction of barrier ribs, and
the spacers are formed on said crossing points in a dot format.

10. A method of manufacturing a plasma display panel comprising the steps of:
aligning one of substrates on which closed-type barrier ribs used for dividing a discharge space into respective cells are formed and the other substrate face to face with each other;
placing a sealing material that is softened upon application of heat on the peripheral portion of the substrates;
placing a spacer that is softened at a temperature higher than the softening point of the sealing material at the time of heating during sealing the substrates to bond the top portion of the barrier ribs and the other substrate to each other, between the top portion of the barrier ribs formed on one of substrates and the other substrate; and
when discharging impurity gases from a discharge space between the substrates at the time of sealing one of the substrates and the other substrate, heating the sealing material to a temperature at which the sealing material is softened, and after impurity gases have been discharged, further heating the substrates to soften the spacer.
